(19) United States
(12) Patent Application Publication
(10) Pub. No.: US 2025/0258299 A1
(43) Pub. Date: Aug. 14, 2025

(54) Federated Learning of Atmospheric Models For Satellite-Based Navigation

(71) Applicant: Google LLC, Mountain View, CA (US)

(72) Inventors: Anton Igorevich Geraschenko, Menlo Park, CA (US); Brian Patrick Williams, Mountain View, CA (US)

(21) Appl. No.: 19/111,216

(22) PCT Filed: Aug. 19, 2022
(86) PCT No.: PCT/US2022/040898

§ 371 Date: Mar. 12, 2025

(51) Int. Cl. G01S 19/23; G06N 7/01

(52) U.S. Cl. CPC G01S 19/23; G06N 7/01

(57) ABSTRACT

The present disclosure is directed to systems and methods enabling federated learning of atmospheric models for satellite-based navigation, via crowdsourcing training data. One method includes, causing, at a computing device, a determination of an error metric based on a difference between a set of measured values and a set of expected values. The set of expected values is based on an atmospheric model and a geolocation. The set of measured values is based on a set of satellite signals received at the computing device from a set of satellites. The error metric may be for the atmospheric model. The method further includes causing a transmission of a data structure from the computing device to an atmospheric model service. The transmitted data structure encodes the error metric (e.g., training data). The atmospheric modeling service employs Bayesian inference and the error metric as a conditional probability to refine the atmospheric model.

### FIELD

The present disclosure relates generally to the development of satellite-based navigation. More particularly, the present disclosure relates to the federated learning of atmospheric models that enable satellite-based navigation.

### BACKGROUND

Various Global Navigation Satellite Systems (GNSS) have been deployed by various agencies. One popular GNSS is the Global Positioning System (GPS), deployed and operated by the United States federal government. In general, a GNSS enables a user equipped with a GNSS-enabled device to navigate the surface of the Earth via the reception of signals transmitted by an array of Earth-orbiting satellites. GNSS-enabled devices are now ubiquitous, in that many mobile and/or wearable devices (e.g., smartphones, tablets, and smartwatches) now include an antenna that are enabled to receive GNSS satellite signals. Among other information, a GNSS satellite signal encodes an identification of the transmitting satellite and a precise timestamp of the transmission (e.g., a time-of-transmission (TOT) timestamp). Upon reception of a GNSS satellite signal, a GNSS-enabled device generates a precise timestamp of the reception (e.g., a time-of-arrival (TOA) timestamp). Via knowledge of an orbital position (based on a precise orbital trajectory model) of the transmitting satellite at the TOT and a time-of-flight (TOF) of the signal (e.g., a difference between the TOA and the TOT), the GNSS-enabled device may estimate a distance between its location and the orbital position of the transmitting satellite at the TOT. Via triangulation methods, the reception of such signals from three or more satellites enables the GNSS device to determine its position on the surface of the Earth (e.g., a geolocation).

It is noted that the accuracy of determining a device's geolocation is highly dependent on an accurate estimation of distance between the device's geolocation and the orbital position of the transmitting satellite at the TOT. The estimation of this distance is highly dependent on determining the “optical path length” of the signal's transmission. Determining the optical path length enables determining a pseudo-range of the satellite. Determining the optical path length for the signal includes performing a path integral of the speed of transmission (e.g., the index of refraction of the transmitting medium) along the path of the transmission.

To reach the device, the satellite signals must traverse the various layers of the Earth's atmosphere. Due to varying densities of electrons, nuclei, ions, atoms, and molecules in the atmosphere, the signals' speed of transmission varies across the atmosphere. Accordingly, to enable accurate satellite-based navigation, atmospheric models may be employed to model the speed of transmission of satellite signals through the Earth's atmosphere.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for satellite-based navigation. The method includes, causing, at a computing device, a determination of an error metric. The determination of the error metric may be based on a difference between a set of measured values and a set of expected values. The set of expected values may be based on an atmospheric model and a geolocation of the computing device. The set of measured values may be based on a set of satellite signals received at the computing device from a set of satellites. The error metric may be for the atmospheric model. The method includes causing a transmission of a data structure from the computing device to an atmospheric model service. The transmitted data structure may encode the error metric.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example atmospheric modeling environment that enables the federation of machine learning for an atmospheric model;

FIG. 2 depicts a block diagram of a process for the federated learning of atmospheric models that is consistent with the various embodiments;

FIGS. 3A-3E demonstrate the iterative refinement of an ionosphere model based on federated learning, as employed in the various embodiments;

FIG. 4A depicts a flowchart diagram of an example method for the federated learning of atmospheric models according to example embodiments of the present disclosure;

FIG. 4B depicts a flowchart diagram of an example method for generating an error metric according to example embodiments of the present disclosure; and

FIG. 5 depicts a flowchart diagram of an example method for updating an atmospheric model according to example embodiments of the present disclosure.

Reference numerals that are repeated across plural figures are intended to identify the same features in various implementations.

### DETAILED DESCRIPTION

### Overview

Generally, the present disclosure is directed to systems and methods enabling federated learning of atmospheric models for navigation via a global navigation satellite system (GNSS). A GNSS-enabled device may employ one or more atmospheric models while performing various calculations associated with satellite-based navigation and/or location services. Due to the complexities in the spatial and temporal dynamics of the Earth's atmosphere, such models may include significant inaccuracies and/or uncertainties. Such limitations in the atmospheric models may result in inaccuracies and/or uncertainties in the navigation and/or location services of the GNSS-enabled device. In the embodiments, while implementing such location and/or navigation services, a GNSS-enabled device may generate “training data” that is indicative of the inaccuracies and/or uncertainties in the atmospheric models. That is, the training data may encode error metrics associated with the models. Such error metrics provide an indication of how the atmospheric models may be refined to enable more accurate navigation and/or location services at the device level. As discussed below, the error metrics encoded in the training data do not include sensitive information for a user of the corresponding GNSS-enabled device. For instance, the error metrics do not indicate the user's geolocation, nor their movements within a region. Rather, the error metrics encode a likelihood function for parameters (or coefficients) of the atmospheric models.

In the embodiments, a plurality of independent GNSS-enabled devices, which may be distributed across a large portion of the Earth's surface, provide such training data to a federated service. In order to reduce network bandwidth resources, each GNSS-enabled device may provide their training data in batches. The federated service employs the training data to iteratively refine and/or update one or more atmospheric models that are employed in the devices' navigation and/or location services. As the atmospheric models are iteratively refined based on training data provided by the devices, the federated service may provide the iterative refinements to the devices. Accordingly, the accuracy and/or uncertainty in the navigation and/or location services of the devices may be iteratively improved over time, without exposing sensitive information of its users to the federated atmospheric modeling service. One non-limiting variant of a GNSS includes the popular Global Positioning System (GPS). However, the embodiments are not limited to GPS, and the embodiments may be employed to virtually any satellite-based navigation system that employs atmospheric models in the determination of a geolocation. Federated learning in the context of the embodiments includes a plurality of independent GNSS-enabled devices providing training data to a centralized and/or federated service (e.g., an atmospheric modeling service).

More specifically, the training data may be generated, at each of the GNSS-enabled devices, via location services of the device. The training data may encode an error metric associated with one or more atmospheric models employed by a location service at the device. The federated service employs the training data to iteratively refine the one or more atmospheric models. As the atmospheric models are iteratively updated, the atmospheric model service may provide the plurality of GNSS-enabled devices with the updated models. The plurality of devices can continue to provide training data to the federated service for future updates to the models. As such, the iterative refinement of atmospheric models converges to a more and more accurate representation of the optical-transmission properties of the Earth's atmosphere. Because the training data may be generated and provided by location services of a plurality of independent GNSS-enabled devices, the federation of learning atmospheric models may include crowdsourcing the generation of data that enables the refinement of atmospheric models employed for satellite-based navigation. That is, while users (or clients) of the atmospheric modeling service are employing the location and/or navigation services of their devices, the users may act as a “crowd” that is continually generating and providing training data. The atmospheric modelling service employs the training data to iteratively improve the accuracies of atmospheric models for satellite-based navigation. Furthermore, the crowd-provided training data does not compromise the privacy of the members of the crowd.

As used throughout, a GNSS-enabled device may include any device configured to receive signals generated by satellites included in a GNSS (e.g., the GPS) array of satellites. Such GNSS-enabled devices include, but are not limited to smartphones, tablets, wearable devices (e.g., smartwatches), GPS-specific receivers (e.g., such as those used in marine environments or hikers), other mobile device, stationary devices, and the like. A GNSS-enabled device may include any device that includes an antenna configured to receive signals from one or more GNSS satellites. In the embodiments, when a GNSS-enabled device determines its location based on the reception of satellite signals and/or other factors, any residual inconsistency between the computed location and its antenna measurements may be considered as a noisy measurement of error in an atmospheric model employed in the computation of the location and/or the antenna measurements. Each determination of a device's location may be employed to compute an error metric for the determination. The error metric may be associated with uncertainties in the atmospheric model employed in the determination of the location and/or the antennae-based measurements. Such error metrics may be aggregated (over multiple measurements) and encoded in a data structure that is provided to the atmospheric model service.

The atmospheric model service receives these aggregated error metrics (accumulated over multiple measurements at the same device) from a plurality of GNSS-enabled devices distributed around the globe. The aggregated error metrics may be received in batches to reduce network bandwidth requirements. The atmospheric model service may employ these crowdsourced error metrics as training data for updating (or refining) the atmospheric model. The atmospheric model service updates (or refines) the atmospheric model based on this training data. The atmospheric model service disseminates the updated model to the devices that provided training data and/or other GNSS-enabled devices. Effectively, GNSS-enabled devices that provide these error metrics act as a global web of sensors (e.g., or a “crowd of distributed sensors”) employed to iteratively refine the atmospheric model. Improving the model improves the accuracy and uncertainties of the navigation and/or location services for various GNSS-enabled devices, including those that don't provide the crowdsourced training data.

In various embodiments, the atmospheric model may include a model of the Earth's ionosphere. However, the embodiments are not limited to refining ionosphere models, and the embodiments may be employed to refine models of additional and/or alternative portions of the Earth's atmosphere. Furthermore, the atmospheric model may be a parameterized model, and refining and/or updating the model may include updating estimated values for the parameters of the model. In at least one embodiment, the atmospheric model may be based on a set of orthogonal basis functions (e.g., Fourier basis functions, spherical harmonic basis functions, and the like). The parameters of the model may include the expansion coefficients for the set of basis functions. Accordingly, updating an atmospheric model may include updating (or refining) estimates for the expansion coefficients for a representation of the ionosphere that are based on a linear summation of an appropriate set of basis functions.

The error metric, as determined by or at a GNSS-enabled device, may include a likelihood function for a joint probability distribution on the space of parameters of the atmospheric model. The joint probability distribution of the likelihood function may include a multi-variable Gaussian (or normal) joint distribution on the model parameters. The atmospheric model service may update the atmospheric model via Bayesian inference techniques. For example, the currently deployed model may include joint-Gaussian distributions on the model parameters, along with the covariance of the parameters. When updating the model, the atmospheric model service may treat the currently deployed model as a prior distribution of the parameters, and the user-supplied likelihood function as a conditional probability that enables updating the prior distribution to generate the posterior probability for the model parameters. In some embodiments, the atmospheric model service may employ a Bayesian filter to update or refine the atmospheric model. Because the distributions are Gaussian distributions, in at least one embodiment, the Bayesian filter may be a Kalman filter. Because the updates to the model are generated via Bayesian inference, the user-supplied likelihood functions need not be stored and/or archived. Each user-supplied likelihood function need only be provided to the Bayesian filter once. In addition to decreasing the amount of long-term storage space required for safeguarding training data, the users need not worry about their “data” being stored and/or “mined” by the federated atmospheric service or other parties.

Aspects of the present disclosure provide a number of technical effects and benefits. For instance, the privacy of users supplying the training data is not compromised. No data sent to the atmospheric model services encodes their device's precise location. Rather, the error metric encodes a likelihood function of the model's parameters, which does not expose sensitive data to the atmospheric model service. The iterative improvement in the model's accuracy occurs in real-time, and the improved model may be continuously provided to GNSS-enabled devices. Once training data (encoding the likelihood functions of the users) is used to generate a model refinement, the training data need not be stored or archived for further use. Individual GNSS-enabled devices may aggregate their error metrics and send a batch of error metrics whenever convenient. Batching the training data at the device-level reduces the required bandwidth and power consumption of the device. Furthermore, batching the uploading of error metrics, at the client device end provides additional protection of the user's location, and direction of travel. For example, via a batch-uploading implementation, a user driving from San Francisco to Mountain View may produce similar error metrics (and thus a similar updating of the atmospheric model) as a user driving from Mountain View to San Francisco. Additionally, combining the updates into batches may obfuscate precise location information without adversely impacting the quality of the updates to the atmospheric model. The amount of required network resources may be adjusted in real-time based on the device's available bandwidth and as the network resources available to the device vary in time and space.

### Example Devices and Systems

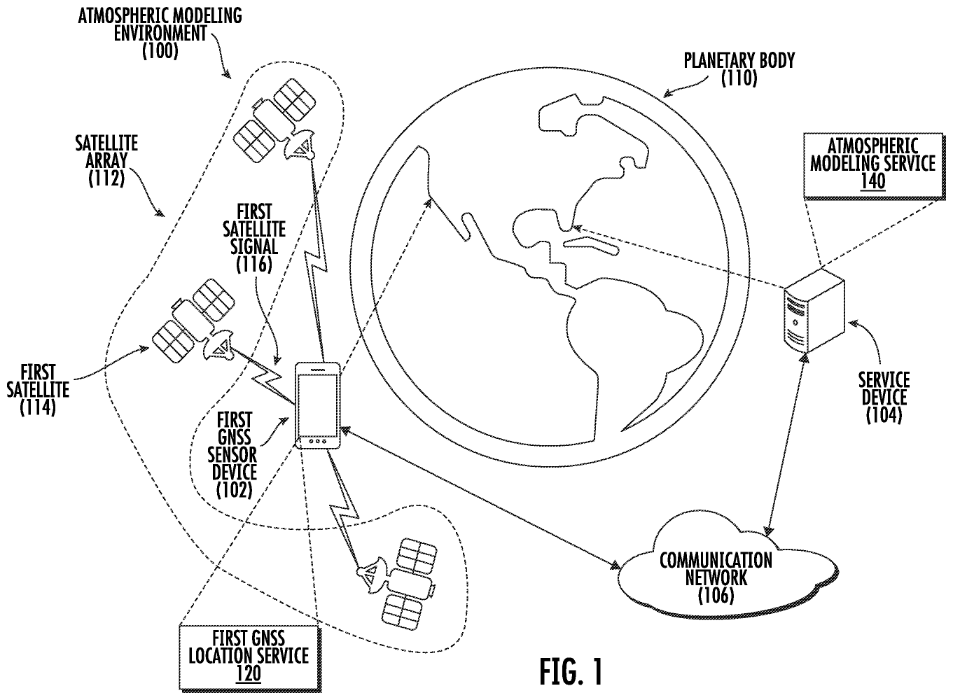

FIG. 1 depicts a block diagram of an example atmospheric modeling environment 100 that enables the federation of machine learning for an atmospheric model. The environment 100 may be employed to enable satellite-based navigation and/or location determination. Environment 100 includes a first GNSS sensor device 102 and a server device 104. The first GNSS sensor device 102 may be a GNSS-enable device that includes an antenna. The environment 100 also includes a planetary body 110, such as but not limited to the Earth. The environment 100 additionally includes a satellite array 112. The satellite array 112 may include a set of satellites, including but not limited to first satellite 114. Each satellite of the satellite array 112 may be orbiting the planetary body 110. Although not explicitly shown in FIG. 1, a plurality of GNSS-enabled devices, including but not limited to first GNSS sensor device 102, may be distributed around the surface of the planetary body 110. In a non-limiting embodiment, first GNSS sensor device 102 is a mobile device (e.g., a smartphone) that is located in the vicinity of the San Francisco Bay area in California.

The plurality of GNSS-enabled devices distributed on the surface of the planetary body 110 are not limited to smartphones, or other mobile devices, but may include any device that is enabled to provide location and/or navigation services that are based on one or more atmospheric models for the planetary body 110. One commonality of each of the GNSS-enabled devices (including first GNSS sensor device 102) is the inclusion of an antenna that is enabled to receive satellite signals transmitted by the satellites of the satellite array. For example, FIG. 1 shows the first GNSS sensor device receiving satellite signals transmitted by the satellites of the satellite array, including but not limited to the reception of a first satellite signal 116 transmitted by the first satellite 114. Each of the GNSS-enabled devices of the plurality of GNSS-enabled devices (including the first GNSS sensor device 102) is communicatively coupled to the server device 104, via a communication network 106. In the non-limiting embodiment of FIG. 1, server device 104 is located within the Miami metropolitan area of Florida.

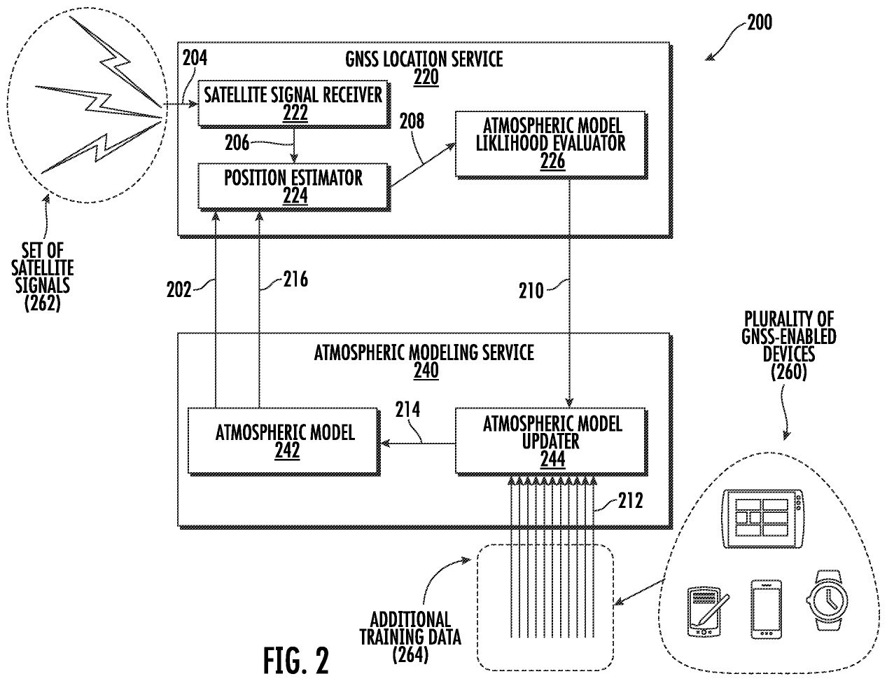

Each of the plurality of GNSS-enabled devices may implement location and/or navigation services. For example, the first GNSS sensor device 102 implements a first GNSS location service 120. The server device 104 implements an atmospheric modeling service 140. Embodiments of the first GNSS location service 120 and the atmospheric modeling service 140 are discussed in conjunction with at least FIG. 2. However, briefly here, in addition to providing navigation and/or location services to a user based on satellite signals and an atmospheric model, first GNSS location service 120 may generate training data for the updating or refining the atmospheric model. The first GNSS location service 120 (as well as the other location services of the other GNSS-enabled devices) may provide the training data to the atmospheric modeling service 140. The atmospheric modeling service 140 may be a federated learning service that receives the training data from the various location services of the various GNSS-enabled devices. The atmospheric modeling service 140 may employ the training data update, refine, and/or revise the atmospheric model.

### Example Federated Learning of Atmospheric Models for Satellite-Based Navigation

FIG. 2 depicts a block diagram of a process 200 for the federated learning of atmospheric models that is consistent with the various embodiments. Process 200 may be implemented by a GNSS location service 220, an atmospheric modeling service 240, and a plurality of GNSS-enabled devices 260. GNSS location service 220 may be similar to first GNSS location service 120 of FIG. 1. Thus, the GNSS location service 220 may be implemented by the first GNSS sensor device 102 of FIG. 1. Atmospheric modeling service 240) may be similar to atmospheric modeling service 140 of FIG. 1. Thus, the atmospheric modeling service 240 may be implemented by server device 104 of FIG. 1.

The GNSS location service 220 is generally responsible for providing location and/or navigation services to a user of the GNSS-enabled device implementing the GNSS location service 220 (e.g., first GNSS sensor device 102 of FIG. 1). The GNSS location service 220 may employ an atmospheric model (e.g., atmospheric model 242) and a set of satellite signals 262 to implement its functionalities. The GNSS location service 220 is also responsible for generating training data. The training data may be employed by the atmospheric modeling service 240 to refine and/or an update of the atmospheric model (e.g., atmospheric model 242). To perform its functionality, GNSS location service 220 may include a satellite signal receiver 222, a position estimator 224, and an atmospheric model likelihood evaluator 226.

The satellite signal receiver 222 is configured to receive the set of satellite signals 262. The position estimator 224 is configured to determine and/or estimate the position (e.g., a geolocation) of the GNSS-enabled device implementing the GNSS location service 220 based on the set of satellite signals 262, the atmospheric model 242, and/or other factors. The atmospheric model likelihood evaluator 226 is configured to determine an error signal based on the atmospheric model 242, the determined and/or estimated geolocation of the GNSS-enabled device, and the set of satellite signals 262. The atmospheric model likelihood evaluator 226 may be configured to encode and/or package the error metric in training data that is provided to the atmospheric modeling service 240. The GNSS location service 220 is configured to provide the training data to the atmospheric modeling service 240.

Details of the error metric are described below. However, briefly here, the error metric, as determined by at the atmospheric model likelihood evaluator 226, may include a likelihood function for joint probability distributions on the space of parameters of the atmospheric model 242. The joint probability distribution of the likelihood function may include Gaussian (or normal) joint distributions on the model parameters. The Gaussian distributions included in the error metric may be characterized by a mean value of each parameter and a covariance between the parameters. The covariance of the distributions may be encoded in a covariance matrix.

The atmospheric modeling service 240 is generally responsible for providing the atmospheric model 242 to the GNSS location service 220. The atmospheric modeling service 240 may additionally receive the training data from the GNSS location service 220, as well as additional training data 264 received by the location services from other GNSS-enabled devices of the plurality of GNSS-enabled devices 260. The plurality of GNSS-enabled devices may or may not include the GNSS-enabled device that is implementing the GNSS location service 220 (e.g., first GNSS sensor device 102 of FIG. 1). The atmospheric modeling service 240 may update the atmospheric model 242 based on the received training data (e.g., the training data received from GNSS location service 220, as well as the additional training data 264 received from the plurality of GNSS-enabled devices.

The atmospheric model 242 may include a model of the Earth's ionosphere. However, the embodiments are not limited to refining ionosphere models, and the embodiments may be employed to refine models of additional and/or alternative portions of the Earth's atmosphere. Furthermore, the atmospheric model 242 may be a parameterized model, and refining and/or updating the model 242 may include updating estimated values for the parameters of the model. In at least one embodiment, the atmospheric model 242 may be based on a set of orthogonal basis functions (e.g., Fourier basis functions, circular harmonic basis function, spherical harmonic basis functions, and the like). The parameters of the model may include the expansion coefficients for the set of basis functions. Accordingly, updating an atmospheric model 242 may include updating (or refining) estimates for the expansion coefficients for a representation of the ionosphere that are based on a linear summation of an appropriate set of basis functions.

The atmospheric model 242 may be employed by the GNSS location service 220 to determine pseudo-ranges for each satellite that transmitted one of the set of satellite signals 262. Based on time-of-transmission (TOT) timestamps encoded in the satellite signals and time-of-arrival (TOA) timestamps generated by the GNSS location service 220, the GNSS location service 220 is configured to determine a time-of-flight (TOF) for each signal. The atmospheric model may model the speed of transmission (e.g., the speed of light or the index of refraction) through the atmosphere. Thus, knowing the speed of transmission at each point along a signal's transmission, and the TOF of the signal, a pseudo-range for the transmitting satellite may be estimated. In the embodiments where the atmospheric model 242 is a ionosphere mode, the atmospheric model 242 may model the density of ions throughout the ionosphere. Neglecting higher-order effects, the index of refraction of the ionosphere may scale approximately linear with the density of ions in the ionosphere.

To perform its various functionalities, atmospheric modeling service 240 may include an atmospheric model 242 and an atmospheric model updater 244. The atmospheric model updater 244 is generally responsible for updating and/or refining the atmospheric model 242 based on error metrics encoded in the training data discussed above. Details of updating the atmospheric model 242 are discussed below. However, briefly here, the atmospheric model updater 244 may update the atmospheric model 242 via Bayesian inference techniques. For example, the currently deployed model may include joint-Gaussian distributions on the model parameters, along with the covariance of the parameters. When updating the model, the atmospheric model updater 244 may treat the currently deployed model as a prior distribution of the parameters, and the GNSS device-supplied likelihood functions as the conditional probability that enables updating the prior distribution to generate the posterior probability for the model parameters. In some embodiments, the atmospheric model updater 244 may employ a Bayesian filter to update or refine the atmospheric model 242. Because the distributions are Gaussian distributions, in at least one embodiment, the Bayesian filter may be a Kalman filter.

Process 200 begins at step 202, where the atmospheric modeling service 240 provides (a current version of) the atmospheric model 242 to the position estimator 224 of GNSS location service 220. At step 204, the satellite signal receiver 222 receives the set of satellite signals 262 from an array of satellites (e.g., satellite array 112 of FIG. 1). The satellite signal receiver may include an antenna configured to receive the set of satellite signals 262. At step 206, the satellite signal receiver 222 provides the set of satellite signals 262 to the position estimator 224. The position estimator 224 may be configured to determine and/or estimate the position of the GNSS-enabled device implementing the GNSS location service 220 based on the atmospheric model 242, the set of satellite signals 262, and one or more other factors. The other factors may include data generated by accelerometers, gyroscopes, and/or other sensors included in the GNSS-enabled device. In at least one embodiment, the position of the GNSS-enabled device is precisely known from other means. For example, the GNSS-enabled device may not be a mobile device, and its position is known and stable over time. In some embodiments, the other factors employed to determine a location may include a static or dynamic IP address of the device, communications through cellular towers, and/or communications through wireless networks, or the like. The location determined by the position estimator 224 may be a geolocation.

At block at step 208, the position estimator 224 provides the geolocation of the GNSS-enabled device to the atmospheric model likelihood evaluator 226. In some embodiments, the atmospheric model 242 and the set of satellite signals 262 are also provided to the atmospheric model likelihood service 226. At step 210, the atmospheric model likelihood evaluator 226 provides training data that encodes an error metric to the atmospheric model updater 226. At step 212, the atmospheric model updater 244 may receive additional training data 264 from the plurality of GNSS-enabled devices 260. At step 214, the atmospheric model updater 244 may update and/or refine the atmospheric model 242 based on the training data, including the training data provided by the atmospheric likelihood evaluator 226, as well as the additional training data 264 provided by the plurality of GNSS-enabled devices 260. At step 216, the updated atmospheric model 242 may be provided to the GNSS location service 220.

More specifically, the position estimator 224 may determine a geolocation and covariances of the geolocation of the GNSS-enabled device. The geolocation may be referenced as a vector x and the covariances of x may be encoded in the covariance matrix Σₓ based on the atmospheric model 242, the set of satellite signals 262, and/or one or more other factors (e.g., data from an accelerator, data from a wireless network, an IP address of the device, a known location of the device, or the like). The satellites of the set of satellites that transmitted the set of satellite signals may be indexed by the positive integer index i, ranging from l to I, where I is a positive integer. Based on the set of satellite signals 262 (e.g., timestamps encoded in the signals) and a model of an orbital trajectory for each satellite), the position estimator 224 may determine an orbital location of each satellite (yᵢ), where the location is encoded in a vector. The determined orbital location of the satellite may be for the TOT corresponding to its signal. Thus, the geometric range of the ith satellite may be represented as the magnitude of the difference between the device's geolocation vector and the vector encoding the satellite's orbital location: e.g., |yᵢ−x|. Either the position estimator 224 and/or the atmospheric likelihood evaluator 226 may determine a normalized geometric range matrix (N). The ith column in the matrix N includes the normalized vector that represents a direction from the device to the ith satellite:

$$\frac{{y}_{i} - x}{\vert {y}_{i} - x \vert}$$

### at the TOT.

Either the position estimator 224 and/or the atmospheric likelihood evaluator 226 may determine a pseudo-range for each satellite (ρᵢ) and a covariance matrix for the pseudo-range of each satellite (Σ_{ρ}_{ᵢ}). Either the position estimator 224 and/or the atmospheric likelihood evaluator 226 may determine a residual vector for the satellites. The components of the residual vector (res) encode the difference between the pseudo-range and the geometric range for the satellites, e.g., resᵢ=ρᵢ−|yᵢ−x|. A covariance matrix for the residual vector may be calculated as: Σᵣₑₛ=(Σ_{ρ}+NΣₓN^{T}).

Either the position estimator 224 and/or the atmospheric likelihood evaluator 226 may determine a pierce-point (pᵢ) and a pierce-angle (θᵢ) for each satellite based on the geolocation of the device and the pseudo-range for the satellite. The pierce-point for the ith satellite may be the location in the atmosphere (e.g., the Earth's ionosphere) that the line-of-sight between GNSS-enabled device and the satellite “pierces” or traverses the atmosphere (e.g., the ionosphere). Likewise, the pierce-angle may be the angle of the device's line-of-site.

As noted above, the atmospheric model may include a set of basis functions and expansion coefficients (or parameters). The basis functions and the expansion coefficients may be indexed by the positive-integer index l, ranging from l to L, where L is a positive integer. The lth basis function may be referenced as ϕₗ and the lth expansion coefficient (or model parameter) may be referenced as cₗ. Either the position estimator 224 and/or the atmospheric likelihood evaluator 226 may generate a measurement matrix (Φ_{i,l}). The measurement matrix may be an l×L matrix with components that are evaluated at the pierce-points and pierce-angles for each of the satellites. The components of the measurement matrix may be evaluated as

$${Φ}_{i , l} = \frac{{Φ}_{l} ( {p}_{i} )}{cos ( {θ}_{i} )} = \frac{\partial {ρ}_{i}}{\partial {c}_{l}} .$$

Accordingly, the measurement matrix encodes a gradient of the pseudo-ranges over the space of model parameters. The information matrix (l) for the user's measurement may be calculated as:

$$I = {Φ}^{T} {\sum }_{res}^{- 1} Φ .$$

As shown below, the information matrix for the user's measurement may be employed to calculate the covariance matrix for the likelihood function.

For the lth expansion coefficient (cₗ), a vector (Φₗ) may be defined as: Φ_{c}=φ_{i,l}·cₗ. Thus, Φ_{c} corresponds to the total density of the atmosphere at the pierce point for the ith satellite. The atmospheric model likelihood evaluator 226 may determine a likelihood function for the set of expansion coefficients: cₗ. For the lth expansion coefficient, the negative log likelihood function may be written (up to a constant) as:

$$\frac{1}{2} {( {Φ}_{c} - res )}^{T} {\sum }_{res}^{- 1} ( {Φ}_{c} - res ) = \frac{1}{2} {c}^{T} ( {Φ}^{T} {\sum }_{res}^{- 1} Φ ) c - {c}^{T} ( {Φ}^{T} {\sum }_{res}^{- 1} res ) + constant .$$

The likelihood function may include a Gaussian distribution for each expansion coefficient, that is characterized by a likelihood mean value (μₗᵢₖ) and a likelihood covariance matrix (Σₗᵢₖ). Based on the above expression for the negative log likelihood for the lth expansion coefficient (cₗ), the coefficient's inverse of the likelihood covariance matrix may be calculated as:

$${\sum }_{lik}^{- 1} = {Φ}^{T} {\sum }_{res}^{- 1} Φ = {{Φ}^{T} ( {\sum }_{ρ} + N {\sum }_{x} {N}^{T} )}^{- 1} Φ .$$

The likelihood mean value for the lth expansion coefficient may be calculated as:

$${\sum }_{lik}^{- 1} {μ}_{lik} = {Φ}^{T} {\sum }_{res}^{- 1} res = {{Φ}^{T} ( {\sum }_{ρ} + N {\sum }_{x} {N}^{T} )}^{- 1} res .$$

The error metric calculated by the atmospheric model likelihood evaluator 226 includes both the likelihood mean value (μₗᵢₖ) and the likelihood covariance matrix (Σₗᵢₖ). As noted throughout, this error metric may be encoded in a data structure that is included in training data provided to the atmospheric model updater 244 at step 210. As also noted, the atmospheric model updater 244 may update the atmospheric model via a Bayesian filter (e.g., a Kalman filter) and the error metric.

The iterative updates to the model may be indexed by the integer t. Accordingly, the joint distribution of the model at index (t−1) may serve as a “prior” for the update at index (t). The prior model (e.g., a joint-Gaussian distribution of model parameters) may be referenced as P(Θ|data₁, . . . , dataₜ₋₁)·P(Θₜ₋₁), where Θ is the set of model parameters. This represents the values of the parameter model at the (t−1) index of iterative updates (i.e., the “prior” for the values of the parameters). The user's likelihood function may be referenced as P(dataₜ|Θ). P(dataₜ|Θ)·P(Θₜ₋₁) includes both the likelihood mean value (μₗᵢₖ) and the likelihood covariance matrix (Σₗᵢₖ), as calculated above. Via a Bayesian filter, the posterior model (e.g., the updated model) may be calculated as:

P(Θ|data₁, . . . , dataₜ)∝P(dataₜ|Θ)·P(Θ|data₁, . . . , dataₜ₋₁)·P(Θₜ)

$$∝ {\sum }_{{Θ}_{t - 1}} P ( {Θ}_{t - 1} ) \cdot P ( {Θ}_{t - 1} )$$

Note that the posterior distribution need not be normalized because such normalization constants may not be critical for the model.

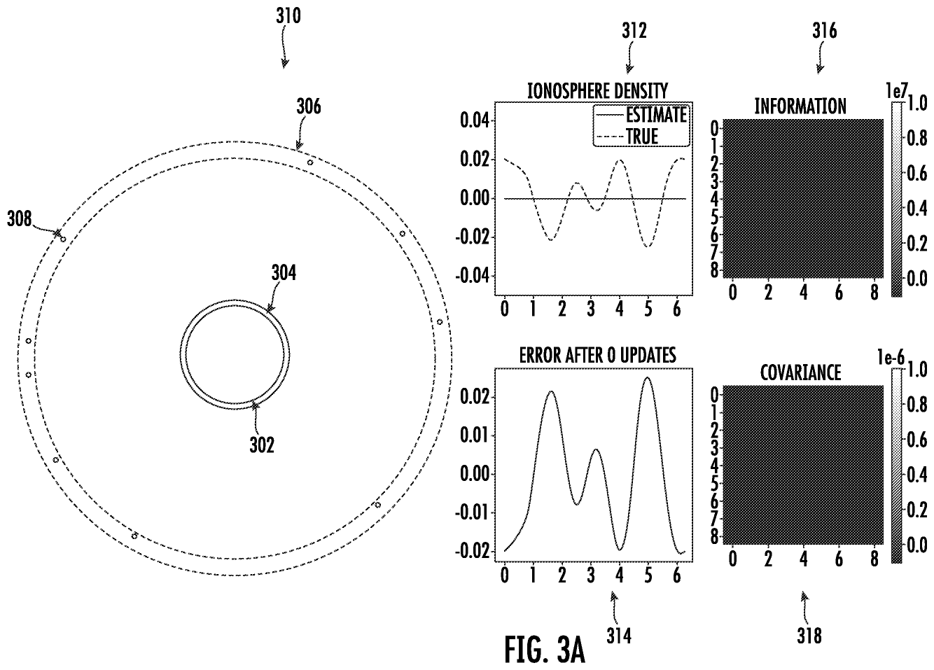

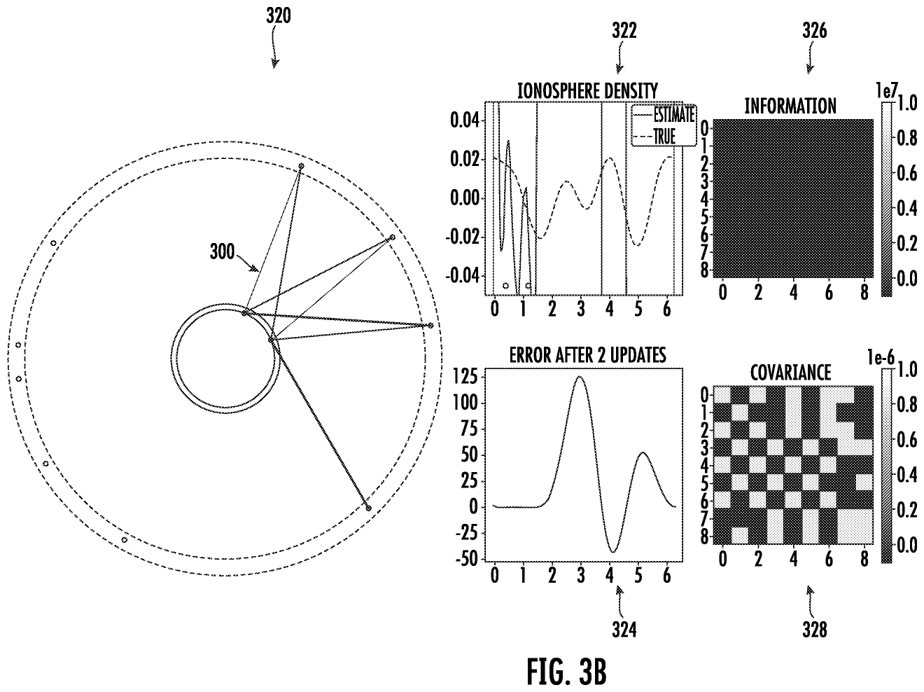

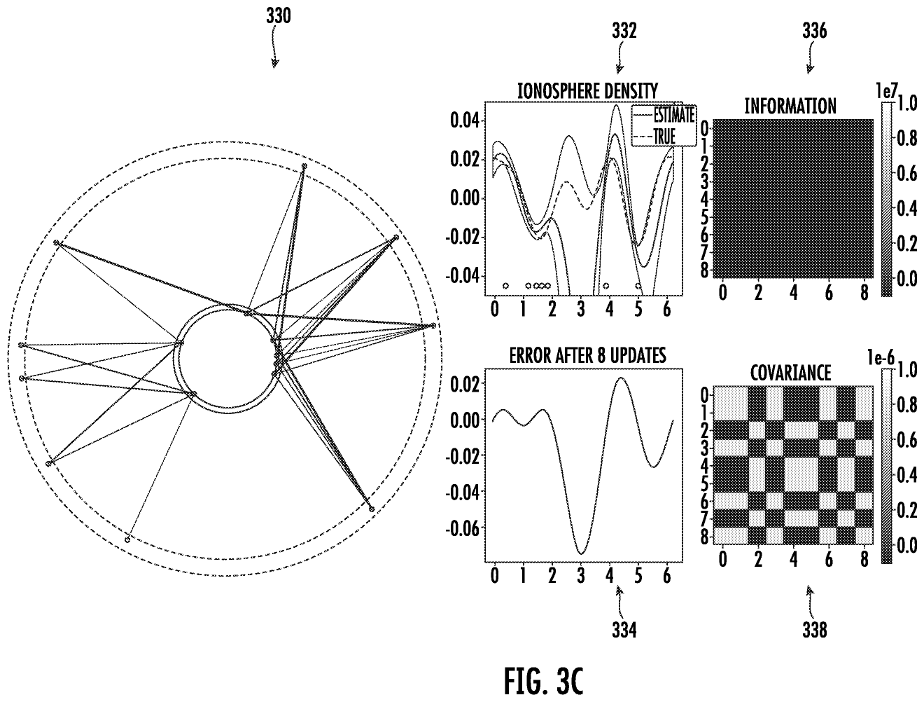

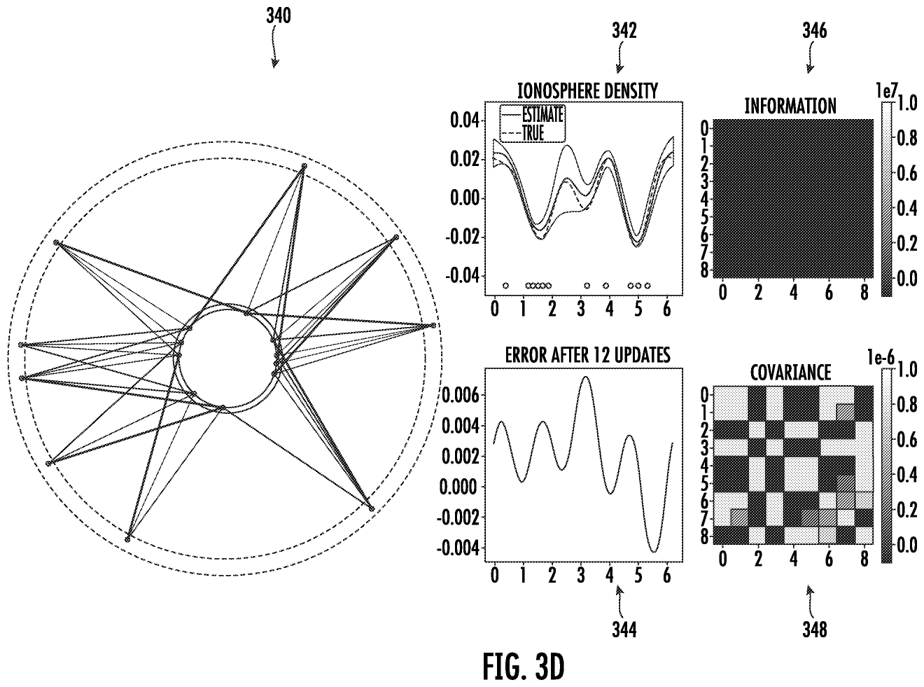

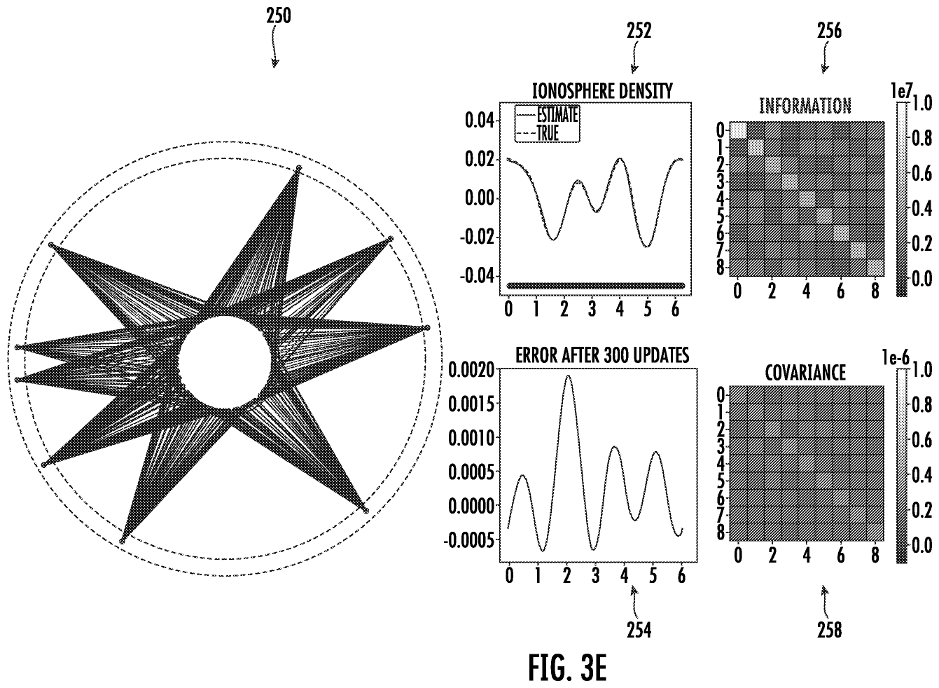

FIGS. 3A-3E demonstrate the iterative refinement of an ionosphere model based on federated learning, as employed in the various embodiments. FIGS. 3A-3E are directed towards a series of experiments that demonstrate the refinement of an ionosphere model until the model converges to a “ground-truth” of the model. In the series of experiments, the surface of the Earth and the ionosphere are modeled as concentric 1D circles, where the Earth is the inner circle and the ionosphere is the outer circle of the Accordingly, the model of the ionosphere may be a 1D model, where the coordinate of interest is an angle sweeping through the ionosphere's corresponding circle. In the embodiments of FIGS. 3A-3E, the set of basis functions for the ionosphere model is the set of circular harmonics. Accordingly, the ionosphere model includes a weighted summation of the circular harmonics, and the model parameters include the expansion coefficients for the summation of the basis functions. In FIGS. 3A-3E, the set of satellites that provide the satellite signals are included in a “thin” orbital ring that is concentric with the Earth's and the ionosphere's concentric circles.

Turning attention to FIG. 3A, FIG. 3A illustrates a first stage 310 of the experiment demonstrating the effectiveness of the federated learning implemented by the various embodiments. In the first stage 310 of the experiment, the model has not been updated and the prior model is a uniform model. In FIG. 3A, the Earth 302 and the ionosphere 304 are shown. The Earth 302 and the ionosphere form a set of two concentric circles, where the Earth 302 is represented by the inner circle and the ionosphere 304 is represented by the out circle of the set of concentric circles. The array of satellites is arranged within the hashed ring 306, which is also concentric to the Earth's and the ionosphere's circle. The dots within the hashed ring 306 represent the satellites. A first satellite 308 of the satellite array is indicated for clarification purposes. The Earth 302, the ionosphere 304, the hashed ring 306, and the array of satellites are shown in each of FIG. 3A, 3B, 3C, 3D, and 3E. However, for clarity purposes, these elements are indicated by element numbers only in FIG. 3A.

For the first stage 310 of the experiment, plot 312 shows the “ground-truth” of the model (as marked as “true” in the legend of the plot 312) and a current version of the model (as marked as “estimate” in the legend of plot 312). The current version of the model may serve as the “prior” version of the model, where prior is used in a Bayesian-sense. The model is a 1D model and is a function of an angle around the Earth 302. The units of the x-axis are radians (e.g., referring to the angle around the Earth 302). The y-axis represents the evaluation of the model at the corresponding angle (of the x-axis). In FIG. 3A, no updates to the model have occurred. Accordingly, the current estimate of the model is a “uniform” model corresponding to the horizontal line. Plot 314 shows the error in the estimation of the model (e.g., the difference between the ground-truth of the model and the current estimate of the model). A color-encoded representation of the information matrix for the model's likelihood function is shown in plot 316. A color-encoded representation of the covariance matrix for the model's likelihood function is shown in plot 318. Because no model updates have occurred yet, the information matrix for the likelihood function and the covariance matrix for the likelihood function are uniformly populated with 0s.

FIG. 3B illustrates a second stage 320 of the experiment. In the second stage 320 of the experiment, the model has been updated via two user-supplied likelihood functions (e.g., error metrics). The two separate geolocations of the two users are shown on the surface of the Earth, as well as the line-of-sight between the two users and the satellites that transmitted the satellite signals, via the signal-transmission lines between the users and the satellites. A first line-of-sight 300 is shown for clarification purposes. Note that the pierce-points and the pierce-angles for each satellite (and for each user) may be geometrically evaluated by the line-of-sight “piercing” the ionosphere. Plot 322 shows the updated estimated value of the model, along with the ground-truth model. The dots near points on the x-axis of plot 322 indicate the two locations on the Earth's surface that correspond to the two likelihood functions. Plot 324 shows the error in the updated estimation of the model. A color-encoded representation of the information matrix for the model's likelihood function is shown in plot 326. A color-encoded representation of the covariance matrix for the model's likelihood function is shown in plot 328.

FIG. 3C illustrates a third stage 330 of the experiment. In the third stage 330 of the experiment, the model has been updated via eight user-supplied likelihood functions. Plot 332 shows the updated estimated value of the model, along with the ground-truth model. The shaded band in plot 332 shows the variance (e.g., as an indication of the confidence and/or uncertainty) of the estimated model. The dots near points on the x-axis of plot 332 indicate the eight locations on the Earth's surface that correspond to the eight likelihood functions. Plot 334 shows the error in the updated estimation of the model. A color-encoded representation of the information matrix for the model's likelihood function is shown in plot 336. A color-encoded representation of the covariance matrix for the model's likelihood function is shown in plot 338.

FIG. 3D illustrates a fourth stage 340 of the experiment. In the fourth stage 340 of the experiment, the model has been updated via twelve user-supplied likelihood functions. Plot 342 shows the updated estimated value of the model, along with the ground-truth model. The shaded band in plot 342 shows the variance (e.g., the uncertainty) of the estimated model. The dots near points on the x-axis of plot 342 indicate the twelve locations on the Earth's surface that correspond to the twelve likelihood functions. Plot 344 shows the error in the updated estimation of the model. A color-encoded representation of the information matrix for the model's likelihood function is shown in plot 346. A color-encoded representation of the covariance matrix for the model's likelihood function is shown in plot 348.

FIG. 3E illustrates a fifth stage 350 of the experiment. In the fifth stage 350 of the experiment, the model has been updated via 300 user-supplied likelihood functions. Plot 352 shows the updated estimated value of the model, along with the ground-truth model. The shaded band in plot 352 shows the variance (e.g., the uncertainty) of the estimated model. The dots near points on the x-axis of plot 354 indicate the 300 locations on the Earth's surface that correspond to the 300 likelihood functions. Plot 354 shows the error in the updated estimation of the model. A color-encoded representation of the information matrix for the model's likelihood function is shown in plot 356. A color-encoded representation of the covariance matrix for the model's likelihood function is shown in plot 358. Note that by 300 updates, the estimated value of the model has converged to the ground-truth of the model, and the error and the variance have converged to near zero. The information matrix and the covariance matrix have converged to be sparse, “near” diagonal matrices.

### Example Methods

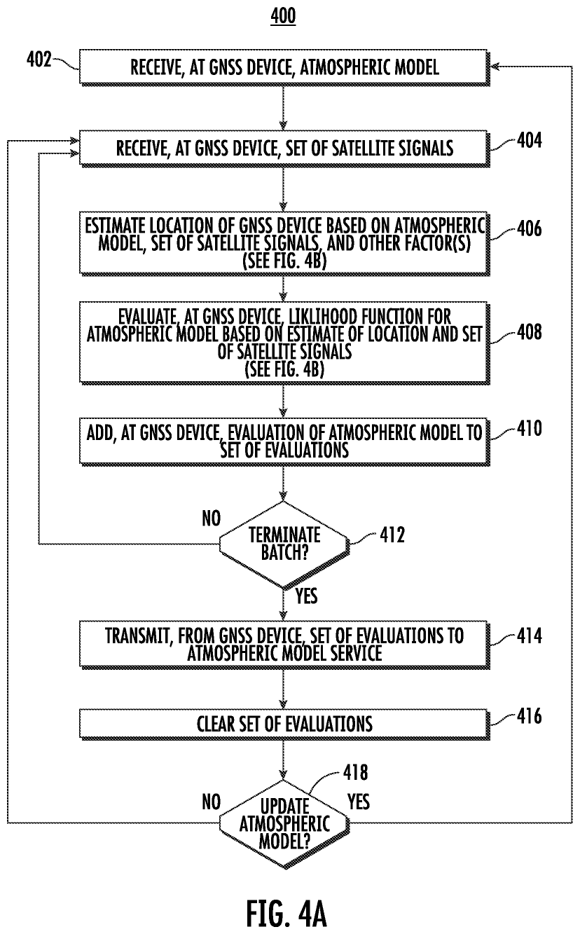

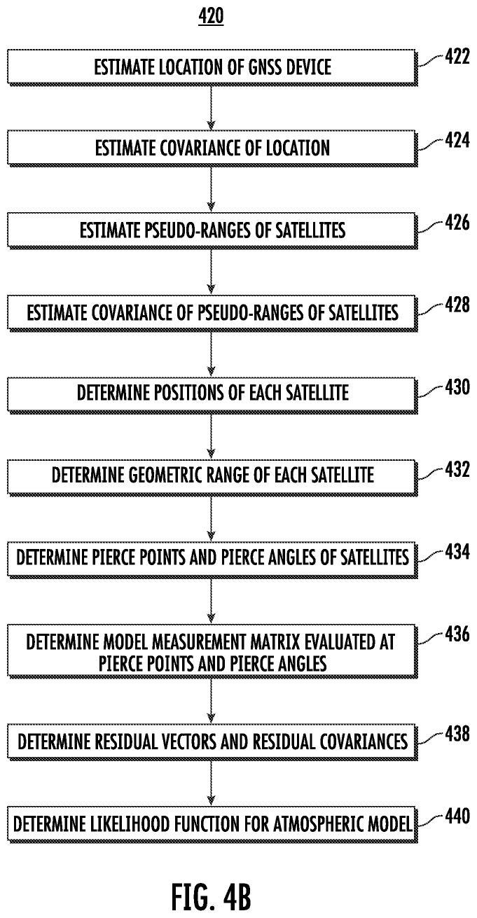

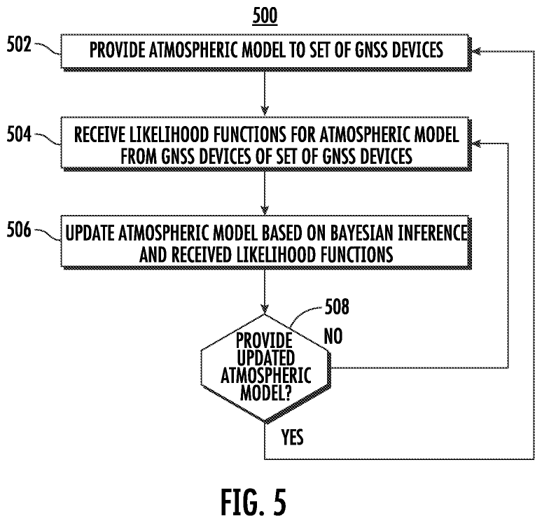

FIGS. 4A-5 depict flowcharts for various methods implemented by the embodiments. Although the flowcharts of FIGS. 4A-5 depict steps performed in a particular order for purposes of illustration and discussion, the methods of the present disclosure are not limited to the particularly illustrated order or arrangement. Various steps of the methods of FIGS. 4A-5 can be omitted, rearranged, combined, and/or adapted in various ways without deviating from the scope of the present disclosure. A location service (e.g., first GNSS location service 120 of FIG. 1 and/or GNSS location service 220 of FIG. 2) and/or an atmospheric modeling service (e.g., atmospheric modeling service 140 of FIG. 1 and/or atmospheric modeling service 240 of FIG. 2) may perform at least some steps in various methods.

FIG. 4A depicts a flowchart diagram of an example method 400 for the federated learning of atmospheric models according to example embodiments of the present disclosure. Method 400 begins at block 402, where a GNSS device receives an atmospheric model. The model may be received from an atmospheric model service. The GNSS device may be a GNSS-enabled device (e.g., first GNSS sensor device 102 of FIG. 1). At block 404, the GNSS device receives a set of satellite signals. At block 406, the GNSS device may estimate and/or determine its location (e.g., geolocation). The determination or estimation of the GNSS device's geolocation may be based on the atmospheric model, the set of satellite signals, and/or one or more other factors (e.g., data from additional sensors of the device, an IP address of the device, communications across a wireless communication network, and the like). Various embodiments of estimating the location of a GNSS device are discussed in conjunction with the least method 420 of FIG. 4B. At block 408, the GNSS device evaluates a likelihood function for the atmospheric model. Evaluating the likelihood function may be based on the GNSS device's estimated location and the set of satellite signals. Various embodiments of evaluating a likelihood function are discussed in conjunction with method 420 a FIG. 4B. The evaluation of the likelihood function may include generating and/or determining an error metric. The error metric may encode the likelihood function. At block 410, and at the GNSS device, the evaluation of the likelihood function is added to a set of evaluations of the likelihood function. The set of evaluations may form a batch of likelihood evaluation functions.

At decision block 412, it is determined whether to terminate the batch of likelihood function evaluations. If the batch is not to be terminated, method 400 may return to block 404, where subsequent set of satellite signals are received. If the batch is to be terminated, method 400 may flow to block 410. At block 410, the set of evaluations of the likelihood function may be transmitted from the GNSS device. In some embodiments, the set of evaluations may be transmitted from the GNSS device to an atmospheric modeling service. In at least one embodiment, prior to being transmitted, the error metric (which encodes the evaluated likelihood functions) may be encoded in a data structure. The data structure may encode training data for updating the atmospheric model. At block 416, set of likelihood function evaluations may be cleared. At decision block 418 it is determined whether an updated atmospheric model is to be received. If an updated atmospheric model is not to be received, then method 400 returns to block 404 to receive additional satellite signals. If an updated atmospheric model is to be received, method 400 returns to block 402.

FIG. 4B depicts a flowchart diagram of an example method 420 for generating an error metric according to example embodiments of the present disclosure. Method 420 begins at block 422, where a location (e.g., a geolocation encoded as a vector a vector x) of the GNSS device is estimated. At block 424, the covariance of the estimated location (e.g., the covariance matrix Σₓ) is determined. At block 426, pseudo-ranges (ρᵢ) for the satellites are estimated. At block 428, covariances of the pseudo-ranges (Σ_{ρ}_{ᵢ}) for the satellites are estimated. At block 430, the positions (e.g., the orbital location) of each satellite (yᵢ) is determined. At block 432, the geometric range (e.g., |yᵢ−x|) of each satellite is determined. At block 434, the pierce-points (pᵢ) and pierce-angles (θₒ) of each satellite is determined. At block 436, a measurement matrix

$$( e . g . , {Φ}_{i , l} = \frac{{ϕ}_{l} ( {p}_{i} )}{cos ( {θ}_{i} )} = \frac{\partial {ρ}_{i}}{\partial {c}_{l}} )$$

that is evaluated at the pierce-points and pierce-angles is generated. At block 438, the residual vectors (e.g., resᵢ=ρᵢ−|yᵢ−x|) and residual covariances (e.g., Σᵣₑₛ=(Σ_{ρ}+NΣₓN^{T})) are determined. At block 440, the likelihood function (e.g., μₗᵢₖ and Σₗᵢₖ) for the atmospheric model is determined.

FIG. 5 depicts a flowchart diagram of an example method 500 for updating an atmospheric model according to example embodiments of the present disclosure. Method 500 begins at block 502, where an atmospheric model is provided to a set of GNSS devices (e.g., a set of GNSS-enabled devices). At block 504, likelihood functions for the atmospheric model may be received from at least a subset of the set of GNSS devices. The likelihood functions may be encoded in one or more error metrics. The received likelihood functions may constitute training data for refining the atmospheric model. At block 506, the atmospheric model may be updated and/or refined based on Bayesian inference techniques and the received likelihood functions. At decision block 508, it is determined whether to provide the updated atmospheric model to the set of GNSS devices. If the updated model is to be provided, method 500 returns to block 502. If the updated model is not to be provided, method 500 may return to block 504.

### Additional Disclosure

One embodiment includes a computer implemented method for satellite-based navigation. The method includes, causing, at a computing device, a determination of an error metric. The determination of the error metric may be based on a difference between a set of measured values and a set of expected values. The set of expected values may be based on an atmospheric model and a geolocation of the computing device. The set of measured values may be based on a set of satellite signals received at the computing device from a set of satellites. The error metric may be for the atmospheric model. The method includes causing a transmission of a data structure from the computing device to an atmospheric model service. The transmitted data structure may encode the error metric.

The method may further include receiving, at a second computing device of the atmospheric model service, the data structure encoding the error metric. The second computing device may update the atmospheric model based on the error metric.

Updating the atmospheric model may comprise providing, at the second computing device, the atmospheric model to a Bayesian filter. The second computing device may provide the error metric to the Bayesian filter. The Bayesian filter may be a Kalman filter. The method may further include providing the updated atmospheric model to the computing device.

In some embodiments, the set of expected values may include a geometric range for each satellite of the set of satellites. The set of measured values may include a pseudo-range for each satellite of the set of satellites.

The atmospheric model may be an ionosphere model that is characterized by a set of basis functions and a set of expansion coefficients corresponding to the set of basis functions.

The error metric may encode a likelihood function. The likelihood function may indicate a joint probability distribution for the set of measured values conditioned on values of a set of parameters of the atmospheric model. The joint probability distribution may include a mean value for each parameter of the set of parameters and a covariance for each parameter of the set of parameters. The joint probability distribution may be a multi-variable Gaussian distribution of the set of parameters.

In another example, the atmospheric model may be or include one or more neural networks comprising a plurality of artificial neurons having a plurality of parameters. The error metric can include or be represented using a loss function and/or a gradient of the loss function (e.g., for each of the plurality of parameters). The atmospheric model can be updated by aggregating the error metric (e.g., the gradient values) from a plurality of client devices and then modifying the parameters of the model based on the aggregated error metric. For example, backpropagation of errors can be used to update the parameters. The updated model having the updated parameters can then be provided to the client devices.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for satellite-based navigation, the method comprising:
determining, at a computing device, an error metric based on a difference between a set of measured values and a set of expected values, wherein the set of expected values is based on an atmospheric model and a geolocation of the computing device, the set of measured values is based on a set of satellite signals transmitted by a set of satellites, and the error metric is for the atmospheric model;
transmitting data comprising the error metric from the computing device to an atmospheric model service; and
receiving, at the computing device, an updated atmospheric model from the atmospheric model service, the updated atmospheric model updated based on an aggregation of the error metric from the computing device with other error metrics determined at other computing devices.

2. The method of claim 1, further comprising:
receiving, at the computing device, the atmospheric model from the atmospheric model service;
receiving, at the computing device, the set of satellite signals transmitted by the set of satellites; and
determining, at the computing device, the geolocation of the computing device based on the atmospheric model and the set of satellite signals.

3. The method of claim 2, wherein determining the geolocation of the computing device is further based on data generated by at least one sensor included in the computing device, wherein the at least one sensor includes at least one of an accelerometer or a gyroscope.

4. The method of claim 1, wherein the updated atmospheric model is further based on a Bayesian filter.

5. The method of claim 4, wherein the Bayesian filter is a Kalman filter.

6. The method of claim 1, wherein the set of expected values includes a geometric range for each satellite of the set of satellites and the set of measured values includes a pseudo-range for each satellite of the set of satellites.

7. The method of claim 1, wherein the atmospheric model is an ionosphere model that is characterized by a set of basis functions and a set of expansion coefficients corresponding to the set of basis functions.

8. The method of claim 1, wherein the error metric encodes a likelihood function that indicates a joint probability distribution for the set of measured values conditioned on values of a set of parameters of the atmospheric model.

9. The method of claim 8, wherein the joint probability distribution includes a mean value for each parameter of the set of parameters and a covariance for each parameter of the set of parameters.

10. The method of claim 8, wherein the joint probability distribution is a multi-variable Gaussian distribution of the set of parameters.

11. A computing system, comprising:
one or more processors; and
one or more non-transitory computer-readable media that, when executed by the one or more processors, cause the computer system to perform operations, the operations comprising:
providing a computing device with an atmospheric model;
receiving, from the computing device, an error metric determined by the computing device based on a difference between a set of measured values and a set of expected values, wherein the set of expected values is based on the atmospheric model and a geolocation of the computing device, the set of measured values is based on a set of satellite signals received at the computing device from a set of satellites, and the error metric is for the atmospheric model; and
updating the atmospheric model based on the error metric; and
providing the updated atmospheric model to at least one of the computing device or another computing device.

12. The computing system of claim 11, wherein updating the atmospheric model comprises:
providing, at the computing system, the atmospheric model to a Bayesian filter; and
providing, at the computing system, the error metric to the Bayesian filter.

13. The computing system of claim 12, wherein the Bayesian filter is a Kalman filter.

14. The computing system of claim 11, wherein updating the atmospheric model is further based on a plurality of error metrics received from a plurality of computing devices that includes the computing device.

15. The computing system of claim 14, wherein the set of expected values includes a geometric range for each satellite of the set of satellites and the set of measured values includes a pseudo-range for each satellite of the set of satellites.

16. The computing system of claim 11, wherein the atmospheric model is an ionosphere model that is characterized by a set of basis functions and a set of expansion coefficients corresponding to the set of basis functions.

17. The computing system of claim 11, wherein the error metric encodes a likelihood function that indicates a joint probability distribution for the set of measured values conditioned on values of a set of parameters of the atmospheric model.

18. The computing system of claim 17, wherein the joint probability distribution includes a mean value for each parameter of the set of parameters and a covariance for each parameter of the set of parameters.

19. One or more tangible non-transitory computer-readable media storing computer-readable instructions that when executed by one or more processors cause the one or more processors to perform operations, the operations comprising:
causing, at a computing device, a determination of an error metric based on a difference between a set of measured values and a set of expected values, wherein the set of expected values is based on an atmospheric model and a geolocation of the computing device, the set of measured values is based on a set of satellite signals received at the computing device from a set of satellites, and the error metric is for the atmospheric model; and
causing a transmission of a data structure from the computing device to an atmospheric model service, wherein the data structure encodes the error metric.

20. The one or more tangible non-transitory computer-readable media of claim 19, the operations further comprising:
receiving, at a second computing device of the atmospheric model service, the data structure encoding the error metric; and
updating, at the second computing device, the atmospheric model based on the error metric.
